(19) United States
(12) Patent Application Publication
(10) Pub. No.: US 2003/0066026 A1
(43) Pub. Date: Apr. 3, 2003

(54) System and method for simulating a laboratory experiment

(76) Inventor: David Jaffe, Raanana (IL)

Correspondence Address: Eitan, Pearl, Latzer & Cohen Zedek, LLP., Suite 1001, 10 Rockefeller Plaza, New York, NY, 10020, US

(21) Appl. No.: 10/217,331

(22) Filed: Aug. 13, 2002

Related U.S. Application Data
(60) Provisional application No. 60/311,800, filed on Aug. 13, 2001.

(51) Int. Cl. G06F 15/00

(52) U.S. Cl. 715/500

(57) ABSTRACT

The present invention includes a virtual experiment authoring application and a virtual experiment presentation application. As part of the present invention, at least two virtual experiment objects, each object including a data structure with at least one parameter defining a physical characteristic of the virtual experiment object, may be placed within a virtual work space in an arrangement defining an initial state of a system formed by the at least two virtual experiment objects. The virtual work space may include at least one global parameter, and a translation module which may derive at least one equation defining a mathematical model of a system formed by the at least two virtual experiment objects within the virtual environment. Also included in the present invention may be a virtual lab area and a simulation engine.

### RELATED APPLICATIONS

This application claims priority from U.S. Provisional Patent Application No. 60/311,800, filed on Aug. 13, 2001, which is hereby incorporated by reference in its entirety.

### FIELD OF THE INVENTION

The present invention relates to the field of virtual presentation systems. More specifically, the present invention relates to a system and method for simulating a laboratory experiment in a virtual computer environment.

### BACKGROUND OF THE INVENTION

Repetitive experimentation has been the comer stone of scientific research since mankind first began to attempt to alter its environment. Guided experimentation has become one tool used by educators to train young minds to think in scientific term. Instructors in scientific fields (e.g. high-school or college instructors in chemistry, physics or biology) would often make demonstrations of chemical reactions or physical phenomenon to a group of students. These demonstrations are meant to prove or disprove certain scientific principles, and in many cases the instructor will request that the student(s) also attempt the experiment.

For the most part experiments performed by students are well defined and their results predictable and well understood. However, execution of these experiments by the students may often be cumbersome, messy, and for the most part not worth the hassle. Broken chemical containers or other objects, spilt chemicals, burned clothing, destroyed instrumentation are only some of the factors which make student experimentation an unattractive option for a science instructor. In certain cases, the cost of providing one or more students with an experiment to perform may not be justified. Therefore, it may be beneficial to provide for a virtual environment within which scientific experiments may be designed by an instructor and repetitively performed by a student.

### SUMMARY OF THE INVENTION

The present invention is a virtual experimentation platform. The present invention may include a virtual experiment authoring application and a virtual experiment presentation application. As part of the present invention, at least two virtual experiment objects, each object including a data structure with at least one parameter defining a physical characteristic of the virtual experiment object, may be placed within a virtual work space in an arrangement defining an initial state of a system formed by the at least two virtual experiment objects. The virtual work space may include at least one global parameter, and a translation module which may derive at least one equation defining a mathematical model of a system formed by the at least two virtual experiment objects within the virtual environment. Also included in the present invention may be a virtual lab area and a simulation engine.

### BRIEF DESCRIPTION OF THE DRAWINGS

The subject matter regarded as the invention is particularly pointed out and distinctly is claimed in the concluding portion of the specification. The invention, however, both as to organization and method of operation, together with containers, features, and advantages thereof may best be understood by reference to the following detailed description when read with the accompanying drawings in which:

FIG. 1 is a block diagram illustration of an embodiment of a virtual experimentation platform according to the present invention;

FIG. 2 is a block diagram of an experiment authoring application according to some embodiments of the present invention;

FIG. 3 is a flow chart with an example of the steps which may be performed using an experiment authoring application according to the FIG. 2;

FIG. 4 is a block diagram of an experiment runtime application according to the present invention;

FIG. 5 is a flow chart illustration of the block of a method of executing a virtual experiment in accordance to the present invention;

FIG. 6 is a conceptual block diagram of some of the functional blocks included in the present invention;

FIG. 7 is a screen shot of a computer application according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a virtual experimentation platform. The present invention may include a virtual experiment authoring application and a virtual experiment presentation application. As part of the present invention, at least two virtual experiment objects, each object including a data structure with at least one parameter defining a physical characteristic of the virtual experiment object, may be placed within a virtual work space in an arrangement defining an initial state of a system formed by the at least two virtual experiment objects. The virtual work space may include at least one global parameter, and a translation module which may derive at least one equation defining a mathematical model of a system formed by the at least two virtual experiment objects within the virtual environment. Also included in the present invention may be a virtual lab area and a simulation engine.

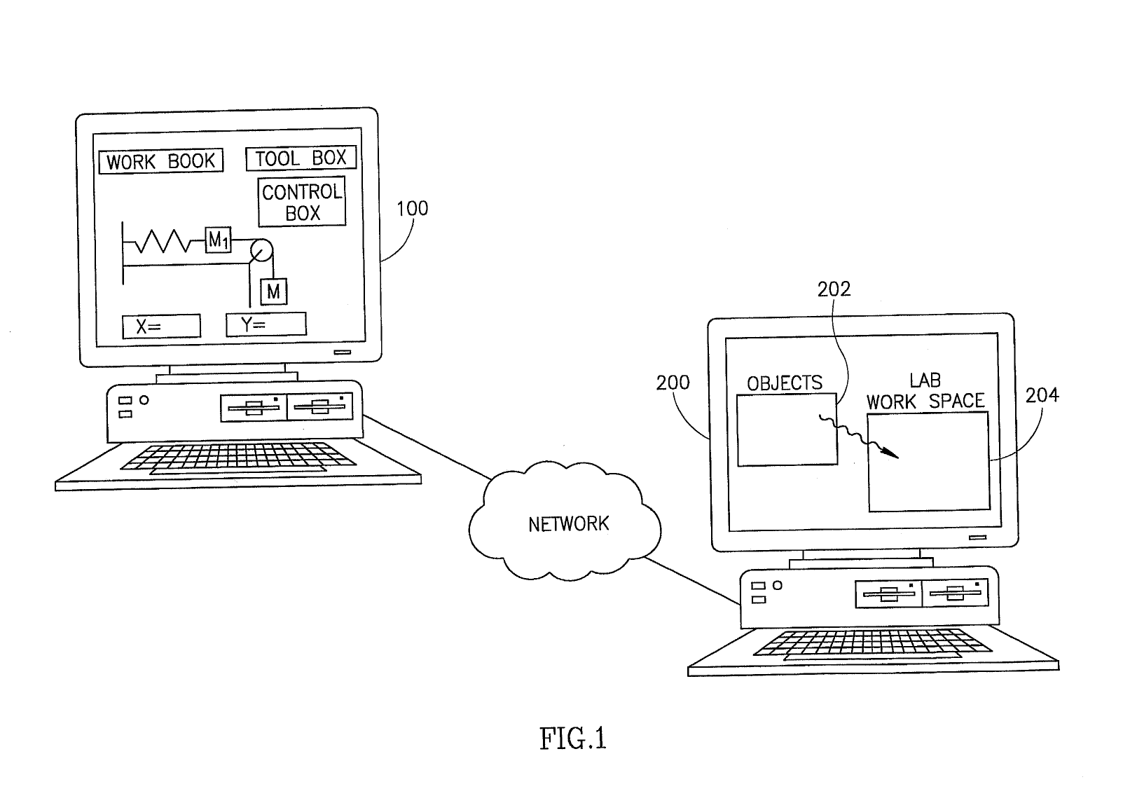

Turning now to FIG. 1, there is shown an embodiment of a virtual experimentation platform according to the present invention. The platform may include a student workstation 100 and an instructor workstation 200. An instructor may place virtual experiment objects 201 selected from a database 202 of virtual experiment objects into a virtual workspace 204 to arrange a virtual experiment therein. The objects may be placed and arranged inside the virtual workspace 204 using a feature called “drag and drop”, which is well known in most graphical user interfaces (“GUI”), and in the Windows operating system.

Each of the virtual experiment objects 201 may represent a tangible object which either participates in an experiment, acts as a catalyst, or is used to measure aspects of the experiment. A virtual experiment object 201 may be a chemical, a composite material, a measuring instrument, or a device used as part of an actual experiment. Each of the virtual experiment objects 201 may include at least one data structure which may store various parameters or characteristics indicative of the real life object the virtual experiment object 201 is meant to represent. For example, if the virtual experiment object 201 is a chemical element, the virtual experiment object's 201 data structure may contain parameters such as the element's atomic weight, reaction properties, an image representation of the elements, etc. . . . If the virtual experiment object 201 represents an instrument or measuring device, the associated data structure may contain one or more parameters defining the instrument's or device's operational features.

Virtual experimental objects 201 may be positioned in the virtual lab workspace 204 in an arrangement corresponding to an arrangement that actual or real objects, which the virtual objects 201 are meant to represent, would have in an actual or real experiment. The virtual experiment objects 201 may be arranged and linked to one another within the virtual workspace 204 so as to depict an actual experiment (e.g. a physics experiment, a chemistry experiment, or an optics experiment). Virtual experiment objects 201 arranged within the virtual workspace may form a virtual “system”, corresponding to a real “system” (a term used in science to define a group of objects interacting with one another in isolation from other objects) formed by real objects linked to one another in the real world.

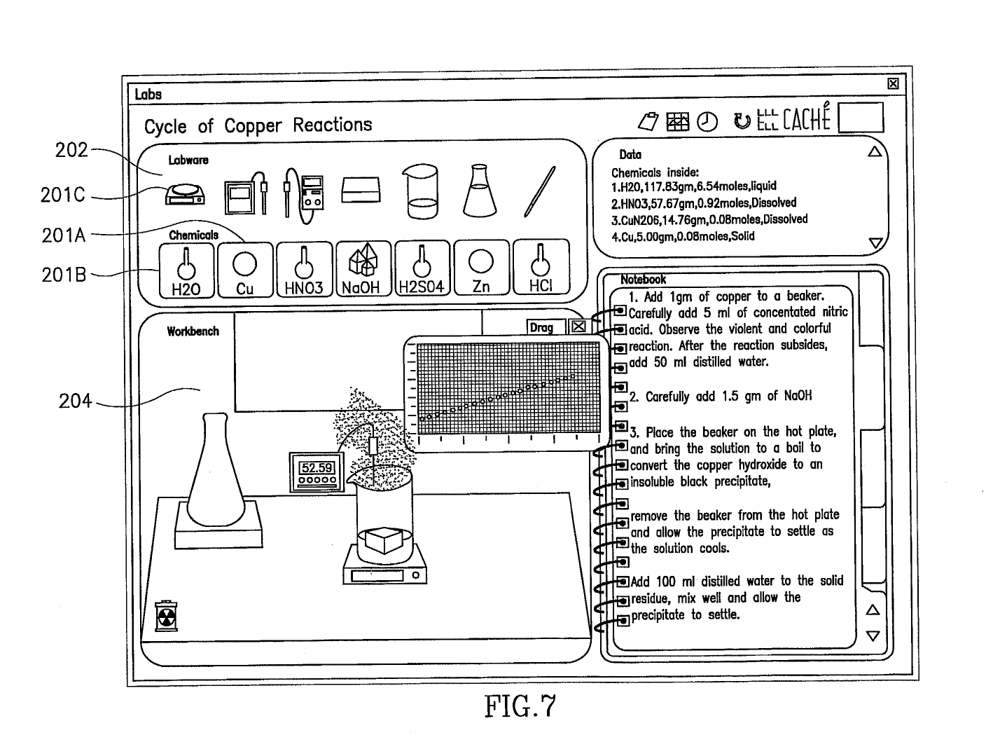

Turing now to FIG. 7, there is shown a screen shot of a computer application according to some embodiments of the present invention, where on the top left portion of the screen there is visible a visual database 202 of virtual experiment objects, 201a to 201c, which may be placed inside the virtual workspace 204. Also visible are objects 201 placed in the workspace 204 in an arrangement simulating an actual experiment.

Turing back to FIG. 1, there is also shown a student workstation 100 connected to the instructor workstation 200 over a data network. In some embodiment of the present invention, however, the instructor workstation 200 and the student workstation 100 may be same computer or may be some other computing device or devices.

A student using the student workstation 100 and running a computer application according to the present invention may simulate an experiment arranged by an instructor. An experiment runtime application, running on the student workstation 100, may receive an experiment data file. The experiment data file may contain the virtual experiment objects 201, instructions to the experiment runtime application on how to display the objects 201 in a virtual lab workspace, and various mathematical equations or models defining the interaction of the objects during the experiment. In some embodiments of the present invention, the experiment data file may not contain instruction on how to display the objects, but rather may contain written instructions to the student regarding how to arrange the objects within the virtual lab workspace, thereby having the student contribute to the experiment.

The runtime application may include a simulation engine which may perform calculation relating the virtual experiment based on the mathematical models or equations within the experiment data file. Typically, a system comprised of multiple objects interacting with one another may be defined by a mathematical model having multiple simultaneous equations. The simulation engine may solve these multiple simultaneous equations for specific conditions which may either be defined by the student, or which may be generated by a number generator.

Various mathematical modeling system and applications are well known. Computer applications which may solve complex series of equations and may display the results for is multiple input values or conditions are well known (e.g. MatLab, Mathentica, etc. . . . ). The simulation engine of the present invention may calculate results for various parameters of the system formed by the virtual experiment objects over a period of time or over a range of temperatures or over one of any number of factors which may influence the state of the system. In some embodiments of the present invention, a student or user may control the variable factors effecting the system and may monitor the result from the simulation engine.

In some embodiments of the present invention, the simulation engine's output may be sent to the virtual lab workspace, where the results may be seen as some change in either the position or some feature of the objects 201 displayed thereon.

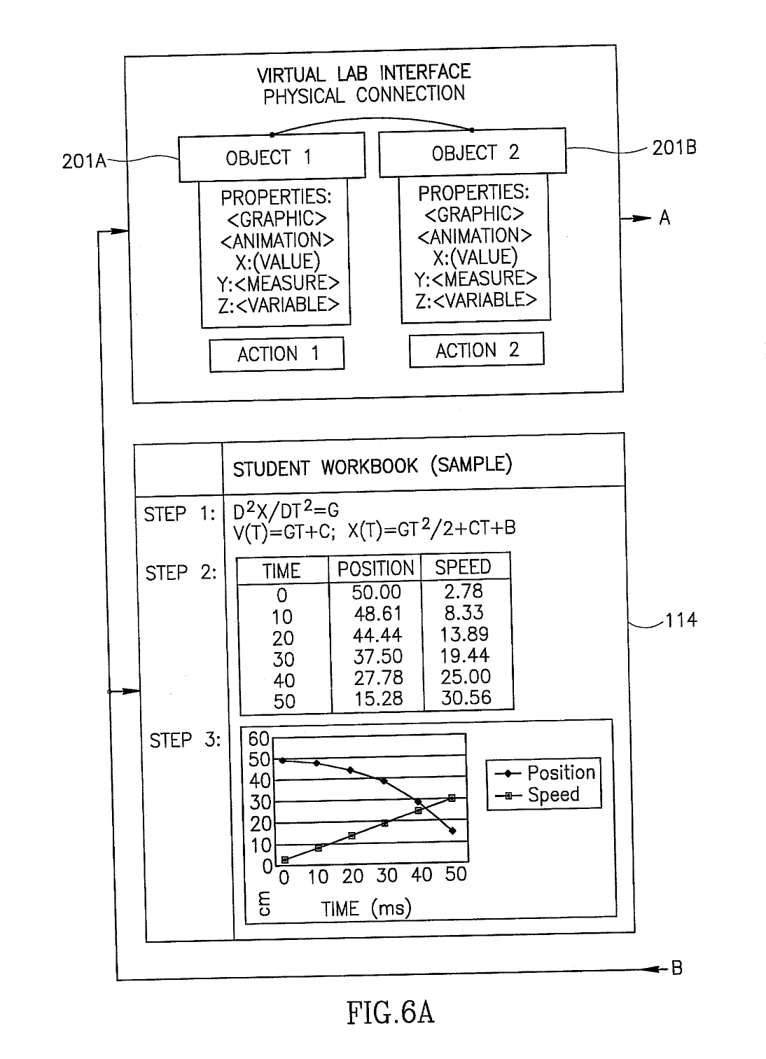

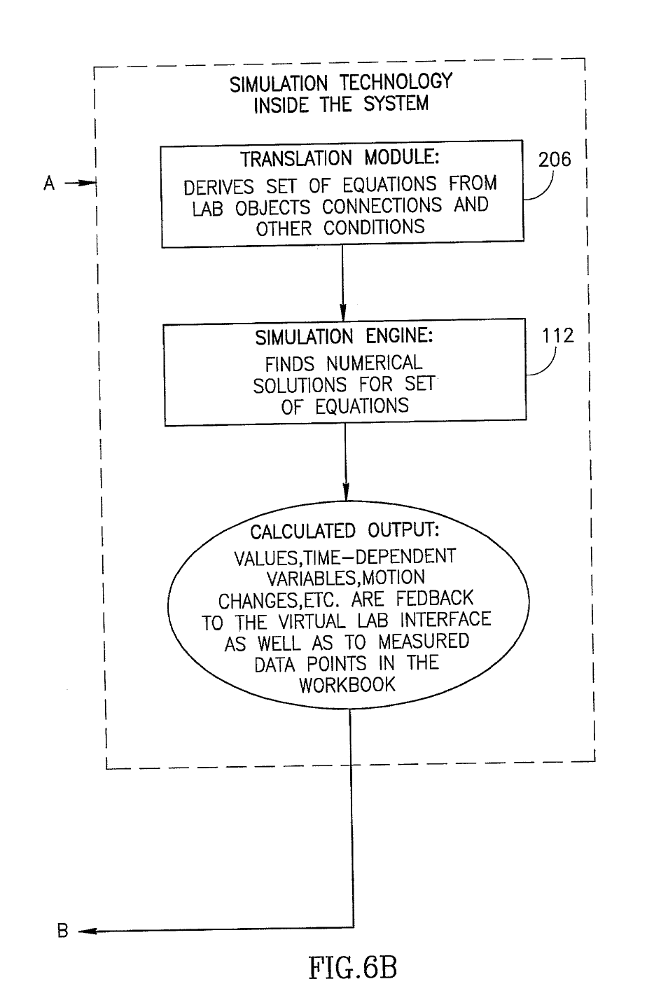

Although FIG. 1 shows the present invention in terms of two separate workstations running, it should be understood that the virtual experiment simulation system and method of the present invention may also be implemented using a single computer or computing unit. Turning now to FIG. 6, there is shown a conceptual block diagram of some of the functional blocks included in the present invention. These functional blocks may interact with one another within a single computing device or across a distributed network. For example, virtual experiment objects 201a and 201b may be functionally associated or linked to one another in a virtual workspace 204.

A translation module 206 may derive a set of equations to define a “system” formed by the linked objects 201, and a simulation engine 112 may find numerical solutions to these equations. The solutions to the equations may be calculated as a function of time, position, temperature or any other parameters or variables relevant to the system and selected by a user. For example, as FIG. 1, the system may calculate the position of a given mass in an oscillating system at some point in time, whereas in the example of FIG. 7, a temperature may be calculated for a given chemical taking part in a reaction.

The output of the simulation engine 112 may be sent to the virtual workspace which may either be the same workspace as the one within which the virtual experiment was authored, or it may be a different workspace (e.g. student virtual workspace within which a student may only execute and watch pre-authored experiments). The output of the simulation engine may also be sent to a workbook 114 where the results may be stored and additional calculations, based on the results, may be performed. A numerical table and graph with the workbook of FIG. 6 shows an example of the content of a workbook used as part of the mass on a spring experiment of FIG. 1.

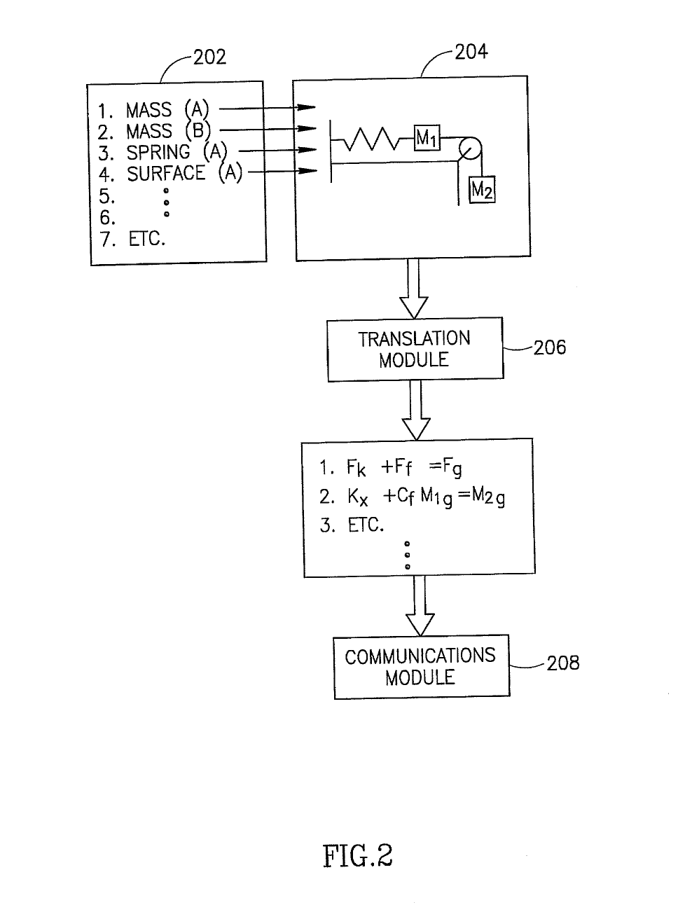

Turning now to FIG. 2, there is shown a block diagram of an experiment authoring application according to some embodiments of the present invention. The experiment authoring application may have an associated virtual experiment object database 202, a virtual workspace 204, a translation module 206, and a communication module 208. The virtual workspace 204 may receive virtual objects 201 in a manner and arrangement indicating the relationship or links between the objects 201. The virtual lab workspace 204 may simulate real work environment and may include one or more parameters indicative of a real work environment (e.g. gravity, temperature, humidity, atmosphere, etc. . . . ). The connected or linked objects 201 within the virtual lab workspace 204 may form a virtual representation of a real “system”.

A translation module 206 may derive a set of equations which collectively may represent a mathematical model of the “system” formed by the set of linked objects within the virtual lab workspace. Creating mathematical models of a real world system is well known. One option for forming such a model is to generate a set of simultaneous equations (see FIG. 2—middle), where each equation defines some limitation to which a portion of the system must conform. Simultaneously solving these equations for a given condition or set of conditions should describe various aspects of the system under such condition(s).

A communication module 208 may package data from the virtual workspace 204 and the mathematical model and send it as an experiment data file to a storage area from which it may be retrieved by one or more students. The communication module may also place into the experiment data file instructions on how to arrange the objects 201 in a student workspace and what are the links or connections between the objects 201. Also included in the experiment data file may be written instructions to the student as to how to perform the virtual experiment.

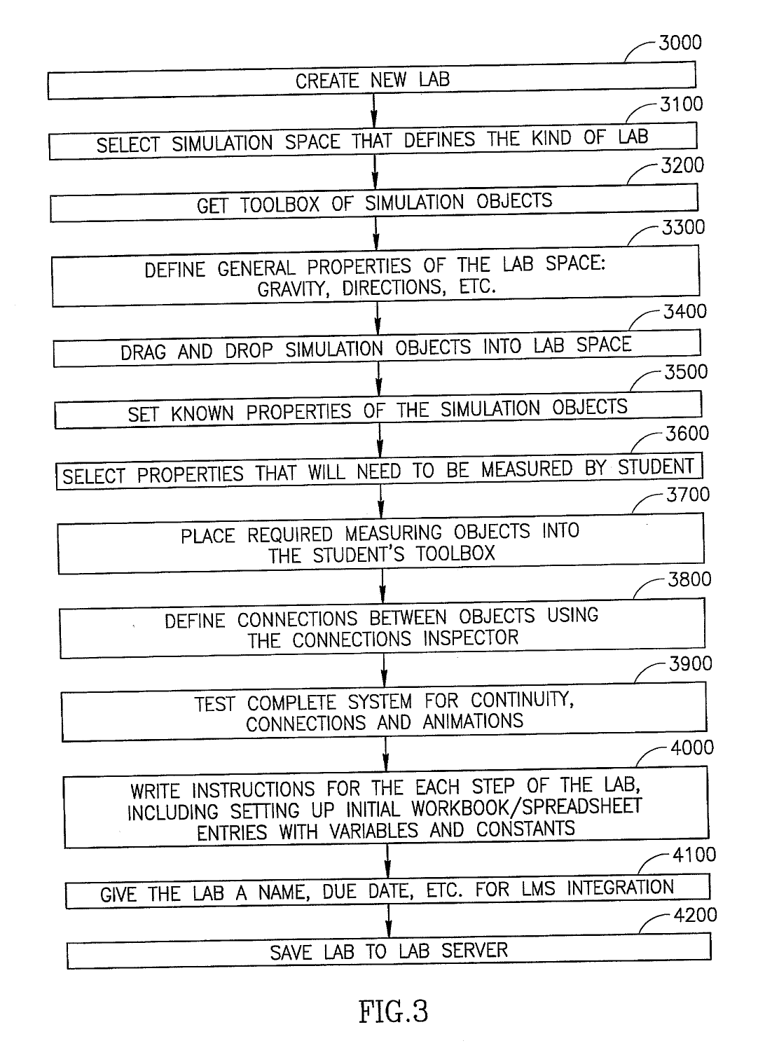

Turning now to FIG. 3, there is shown a flow chart with an example of the steps wich may be performed using an experiment authoring application according to the FIG. 2. Some of the steps may include creating a new virtual lab 3000, selecting a simulation space that defines the kind of lab which is desired for the experiment 3100, and getting a toolbox (database) with a simulation or virtual experiment objects 3200, defining general or global properties of the lab space (e.g. gravity, temperature, etc. . . . ) 3300. In order to author an experiment, once the preliminary steps are taken, a user may drag and drop objects in the lab workspace 3400, set properties (e.g. mass, temperature, etc. . . . ) of the objects 3500, select properties which will need to be measured or determined by a student during the experiment 3600, place measuring objects into a toolbox 3700, define connections between objects 3800, and save the experiment (i.e. entire lab or experiment file) in a location accessible by one or more students.

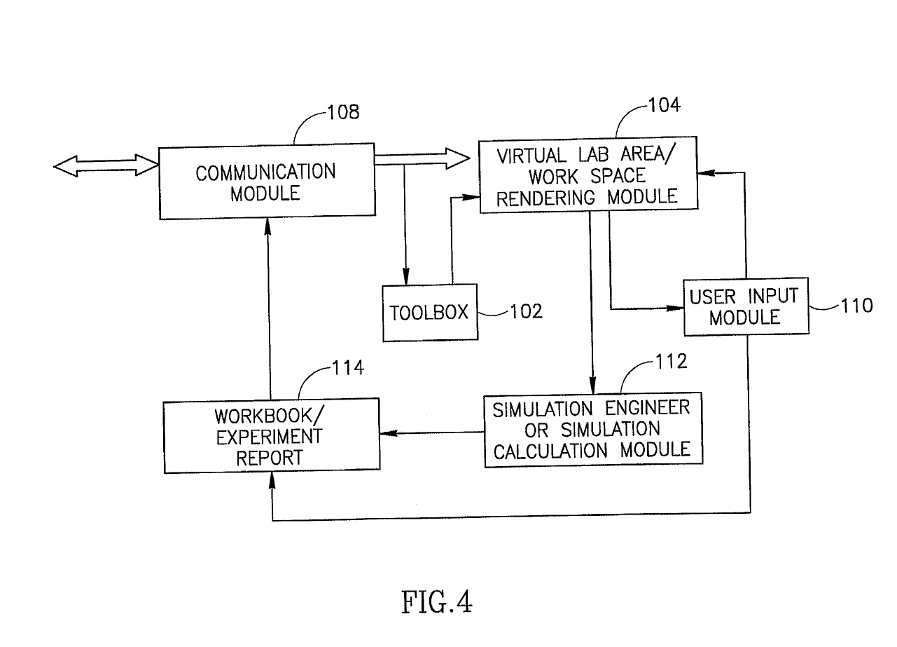

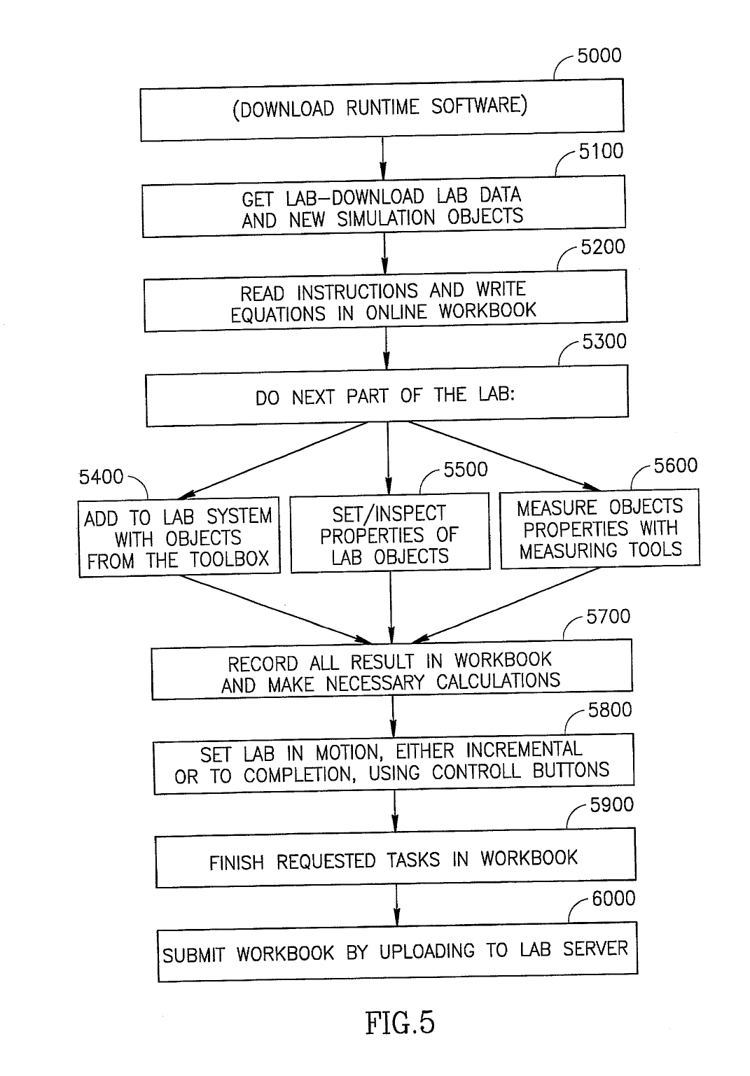

Turning now to FIG. 4, there is shown a block diagram of an experiment runtime application according to the present invention. The runtime application may include a communication module which may access or retrieve an experiment data file. The experiment data file may contain certain virtual experiment objects, a portion of which may be placed within a virtual lab work area or workspace 104, and another portion which may be placed in a toolbox 102. Typically, objects participating in the experiment, forming the system to be modeled, are place in the workspace 104. Instrumentations or measuring device objects may be place within the tool box 102, and a user may then place the instrumentation objects(s) in selected positions within the virtual workspace 104.

A user input module may receive input from a user of the runtime application and may apply the input to various parameters of the virtual experiment. For example, the user input module may allow a user to change either global parameters (e.g. gravity, temperature, etc. . . . ) of the environment simulated in the virtual workspace or specific parameters (e.g. mass) of specific virtual experiment objects. The user input module may also allow a user to enter and modify data and formulas in a workbook 114. The workbook 114 may be an application with rows and columns where data may be entered, tabulated, manipulated and where calculations may be performed. A simulation engine 112 may perform calculations as describer above, and the results may be sent to the virtual workspace 104 and/or to the workbook 114.

Reference is made now to FIG. 5 which is a flow chart illustration of the method of executing a student runtime application in accordance with some embodiment of the present invention. Initially, a student may be required to download and install the runtime software to enable the execution of the virtual lab on the student's workstation (block 5000). However, block 5000 may be omitted if it is not necessary to download and/or install the run time software on the student's workstation. Lab data and new simulation objects may then be obtained (block 5100). The lab or experiment data file may include virtual experiment objects, measuring objects, etc. . . . The student may be required to read instructions and to write a set of modeled equations in an online workbook (block 5200). Next, the student may elect, or the student may be required, to do one or more of the following: add objects to workspace from the toolbox (block 5300), set or inspect properties of lab objects (block 5400), and/or measure object properties with measuring tools (5500). Some or all of the results of the experiment may be recorded in the workbook and necessary calculation may be performed (block 5600). The lab simulation or experiment may be executed, setting the lab in motion (block 5700). The lab may be “set in motion” when the simulation module provides an output which updates the virtual workspace, thereby making the work space appear “in motion.” The lab simulation may either be incremental or run from an initial state to completing, and may be controlled by the user input module 110. The requested tasks may be completed in the student's work book (block 5800), and the work book may be submitted (block 5900), for example by uploading the workbook to a lab server or other digital storage space from which it may be retri eve by an instructor.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A virtual experiment authoring application comprising;
at least two virtual experiment objects, each said virtual experiment object comprising a data structure with at least one parameter defining a physical characteristic of said virtual experiment object;
a virtual work space adapted to receive said at least two virtual experiment objects in an arrangement defining an initial state of a system formed by said at least two virtual experiment objects, said virtual work space comprising at least one global parameter;
a translation module adapted to derive at least one equation defining a mathematical model of the system formed by said at least two virtual experiment objects.
a communication module adapted to transmit to a representation of said at least two virtual experiment objects and said at least one equation.

2. A method of authoring a virtual experiment comprising;
placing at least two virtual experiment objects from a database of virtual experiment objects into a virtual work space having at least one global parameter;
defining relationships between the at least two virtual experiment objects by placing the objects within the virtual environment;
deriving at least one equation defining a mathematical model of the interaction of said at least two virtual experiment object within the virtual environment;
transmitting a representation of said at least two virtual experiment objects and said at least one equation.

3. A virtual experiment runtime application comprising;
a communication module to receive the virtual experiment data, wherein said virtual experiment data comprises at least two virtual experiment objects and at least one equation defining a relationship between said at least two virtual experiment objects;
a virtual lab area within which the at least two virtual experiment objects are displayed in an initial condition;
a simulation engine to calculate at least one parameter of said at least two experiment data objects based on said at least one equation; and
wherein said virtual lab area is adapted to display a change in said at least one parameter.

4. A method of simulating a virtual experiment comprising;
receiving data relating to the virtual experiment data, wherein said data comprises at least two virtual experiment objects and at least one equation defining a relationship between said at least two virtual experiment objects;
placing within a virtual lab area said at least two virtual experiment objects;
displaying said at least two virtual experiment objects an initial condition;
calculating at least one parameter of said at least two experiment data objects based on said at least one equation; and
displaying a change in said at least one parameter.
